(19) United States
(12) Patent Application Publication
(10) Pub. No.: US 2001/0052436 A1
(43) Pub. Date: Dec. 20, 2001

(54) Electric power steering apparatus

(76) Inventors: Hiroshi Fujita, Tochigi (JP); Yoshitaka Kubo, Tochigi (JP)

Correspondence Address: ORUM & ROTH, 53 West Jackson Boulevard, Chicago, IL, 60604-3606, US

(21) Appl. No.: 09/793,262

(22) Filed: Feb. 26, 2001

(30) Foreign Application Priority Data
Jun. 19, 2000 (JP) 2000-183607

(51) Int. Cl. B62D 5/04

(52) U.S. Cl. 180/443

(57) ABSTRACT

In an electric power steering apparatus, an O-ring is interposed between a middle portion in an axial direction of a first faucet portion provided in a gear housing and a middle portion in an axial direction of a second faucet portion provided in a motor case when fitting the second faucet portion to the first faucet portion.

### BACKGROUND OF THE INVENTION

1. Field of the Invention

The present invention relates to an electric power steering apparatus.

2. Description of the Related Art

An electric power steering apparatus is structured, as described in Japanese Patent Application Laid-Open Publication (JP-A) No. 11-301499, such that a motor case of an electric motor is mounted to a gear housing and a torque of the electric motor is transmitted to a rack shaft via a gear train within the gear housing, thereby assisting in steering operation. An output shaft of the electric motor and a drive shaft supported to the gear housing are coaxially connected to each other by fitting a second faucet portion provided in the motor case to a first faucet portion provided in the gear housing, thereby smoothly transmitting the torque of the electric motor.

However, in the prior art, play exists between the first faucet portion in the gear housing and the second faucet portion in the motor case. This play makes the coaxial connection between the output shaft of the electric motor and the drive shaft of the gear housing difficult, thereby deteriorating a torque transmitting performance of the electric motor.

Many difficulties exist in making a working tolerance between the first faucet portion and the second faucet portion severe in order to improve fitting accuracy therebetween. Further difficulties exist in assembling the electric motor. When axially assembling the output shaft of the electric motor with the drive shaft of the gear housing, there is play between the first faucet portion and the second faucet portion.

In this case, in Japanese Patent Application Laid-Open Publication (JP-A) No. 11-301499, there is disclosed a structure in which an O-ring is interposed in a fitting portion between an inner peripheral portion of the gear housing and an outer peripheral portion of the motor case. However, since the O-ring is positioned at an end portion between the inner peripheral portion and the outer peripheral portion, the O-ring is brought into contact with a beveled portion or a burred portion in the inner peripheral portion or the outer peripheral portion even when the inner peripheral portion and the outer peripheral portion are faucet connected to each other. Thus, the gear housing and the motor case are not centered by the O-ring and axially assembled.

### SUMMARY OF THE INVENTION

An object of the present invention is to coaxially connect an output shaft in an electric motor side to a drive shaft in a gear housing side in an easy manner in an electric power steering apparatus so as to improve torque transmitting performance of the electric motor.

In accordance with the present invention, there is provided an electric power steering apparatus comprising:

a gear housing; and

a motor case of an electric motor mounted to the gear housing,

wherein an O-ring is interposed between a middle portion in an axial direction of a first faucet portion provided in the gear housing and a middle portion in an axial direction of a second faucet portion provided in the motor case when fitting the second faucet portion to the first faucet portion.

### BRIEF DESCRIPTION OF THE DRAWINGS

The present invention will be more fully understood from the detailed description given below and from the accompanying drawings which should not be taken to be a limitation on the invention, but are for explanation and understanding only.

The drawings

FIG. 1 is a front elevational view showing an electric power steering apparatus in a partly broken manner;

FIG. 2 is a cross sectional view along a line II-II in FIG. 1;

FIG. 3 is a cross sectional view along a line III-III in FIG. 2; and

FIG. 4 is an enlarged cross sectional view of a main portion in FIG. 3.

### DESCRIPTION OF THE PREFERRED EMBODIMENTS

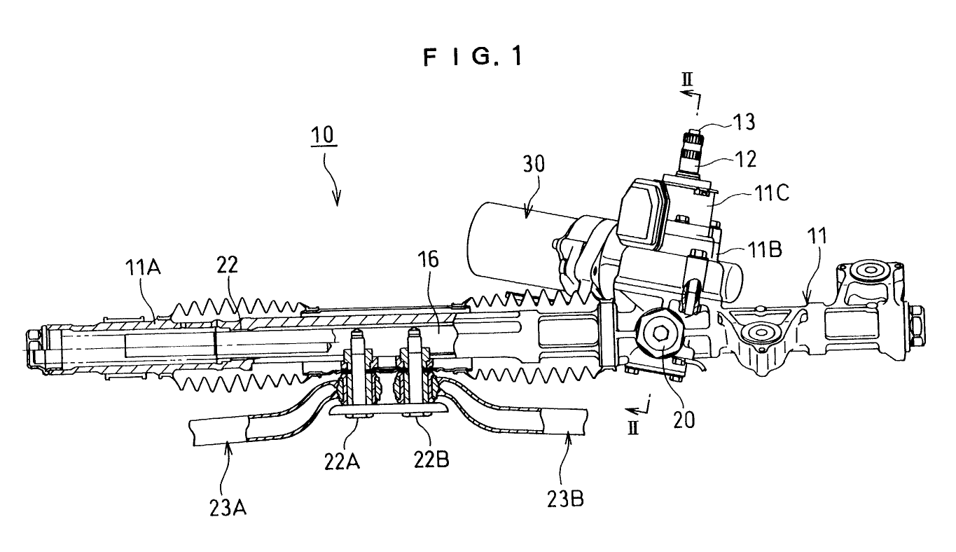

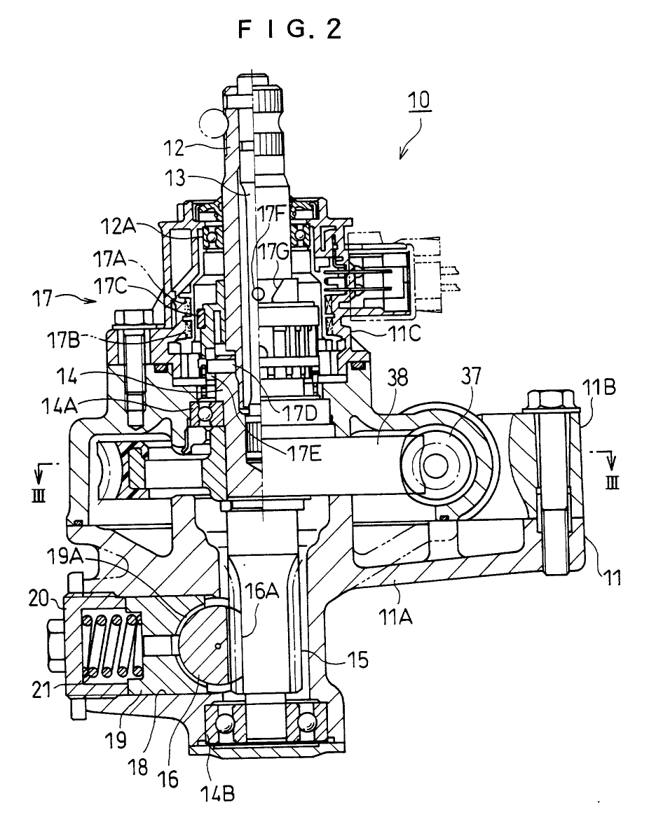

An electric power steering apparatus 10 has a gear housing 11 (first to third gear housings 11A to 11C) fixed to a vehicle body frame or the like by a bracket (not shown), as shown in FIGS. 1 and 2. The electric power steering apparatus 10 is structured such that a pinion shaft 14 is connected to a steering shaft 12 to which a steering wheel is connected, via a torsion bar 13. A pinion 15 is provided in the pinion shaft 14 and a rack shaft 16 provided with a rack 16A engaged with the pinion 15 is supported to the first gear housing 11A in such a manner as to freely move in a lateral direction. A steering torque detecting apparatus 17 is provided between the steering shaft 12 and the pinion shaft 14. In this case, the steering shaft 12 and the pinion shaft 14 are supported to the gear housing 11 via bearings 12A, 14A and 14B.

The steering torque detecting apparatus 17 is, as shown in FIG. 2, is provided with two detecting coils 17A and 17B surrounding a cylindrical core 17C engaged with the steering shaft 12 and the pinion shaft 14 in the third gear housing 11C. The core 17C is provided with a vertical groove 17E engaging with a guide pin 17D of the pinion shaft 14 so as to freely move only in an axial direction. It is also provided with a spiral groove 17G engaging with a slider pin 17F of the steering shaft 12. Accordingly, when steering torque applied to the steering wheel is applied to the steering shaft 12 and a relative displacement in a rotational direction is generated between the steering shaft 12 and the pinion shaft 14 due to an elastic torsional deformation of the torsion bar 13, the displacement in the rotational direction of the steering shaft 12 and the pinion shaft 14 causes to displace the core 17C in an axial direction. Thus, an inductance of the detecting coils 17A and 17B due to a magnetic change in the periphery of the detecting coils 17A and 17B which is generated by the displacement of the core 17C is changed. That is, when the core 17C moves toward the steering shaft 12, there is an increase in inductance of the detecting coil 17A disposed in the area to which the core 17C moves. Conversely, there is reduction of inductance of the detecting coil 17B disposed in the area from which the core 17C moves, whereby it is possible to detect the steering torque due to the change of the inductance.

A rack guide 19 is installed, as shown in FIG. 2, in a cylinder portion 18 provided in a portion opposing to the pinion 15 with respect to one end of the rack shaft 16 within the first gear housing 11A. The rack guide 19 (a bush 19A) is elastically provided in an area of the rack shaft 16 by a spring 21 supported on a back surface by a cap 20 attached to the cylinder portion 18 so as to press the rack 16A of the rack shaft 16 to the pinion 15 and sidably support one end of the rack shaft 16. In this case, another end side of the rack shaft 16 is supported by a bearing 22. Further, right and left tie rods 23A and 23B are connected to an intermediate portion of the rack shaft 16 by connecting bolts 22A and 22B.

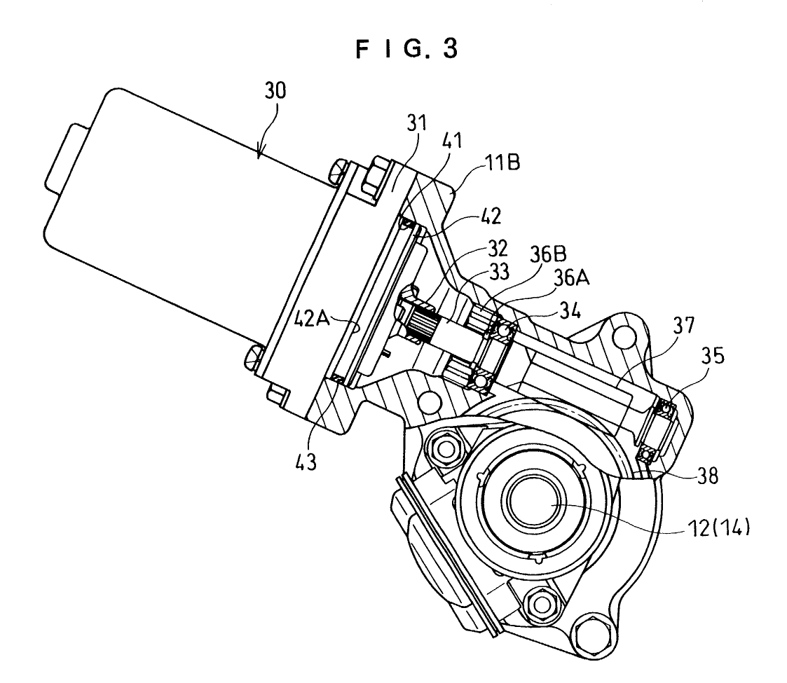

A motor case 31 of an electric motor 30 is mounted to the second gear housing 11B, as shown in FIG. 3. A drive shaft 33 is spline connected to an output shaft 32 in the electric motor 30 side, and both ends of the drive shaft 33 are supported to the gear housing 11B by bearings 34 and 35. An inner wheel and an outer wheel of the bearing 34 are respectively held by a stopper ring 36A and a lock nut 36B. A worm gear 37 is integrally provided in a middle portion of the drive shaft 33, and a worm wheel 38 engaged with the worm gear 37 is fixed to a middle portion of the pinion shaft 14. A torque generated by the electric motor 30 is applied to the rack shaft 16 as an assisting force via an engagement between the worm gear 37 and the worm wheel 38 and an engagement between the pinion 15 and the rack 16A, thereby assisting a steering force applied to the steering shaft 12 by a driver.

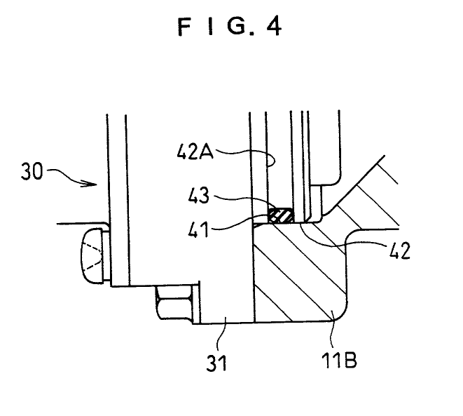

Accordingly, the motor case 31 of the electric motor 30 is supported to the gear housing 11B in a manner mentioned below (FIG. 4). That is, when fitting a second faucet portion 42 provided in the outer area of the motor case 31 to a first faucet portion 41 provided in the inner area gear housing 11B, an O-ring 43 is interposed between a middle portion in an axial direction of the first faucet portion 41 and a middle portion in an axial direction of the second faucet portion 42. At this time, an O-ring 43 is attached to an annular groove 42A in the middle portion in the axial direction of the second faucet portion 42. In this case, an annular groove for attaching the O-ring may be provided in the middle portion in the axial direction of the first faucet portion 41, however, the annular groove 42A is not essential.

The first faucet portion 41 of the gear housing 11B, the second faucet portion 42 of the motor case 31 and the annular groove 42A are worked and finished at a fixed working tolerance. Sizes of the middle portions in the axial direction thereof with which the O-ring 43 is brought into contact are defined by the worked and finished sizes. An inner end portion and an outer end portion in the axial direction of the first faucet portion 41, and an inner end portion and an outer end portion in the axial direction of the second faucet portion 42 are formed in beveled portions or burred portions for the purpose of preventing the O-ring 43 from being damaged, and sizes thereof are out of the working tolerance for finishing mentioned above.

Therefore, in accordance with the present embodiment, the following effects can be obtained.

(1) The O-ring 43 is interposed in the fitted portion between the first faucet portion 41 of the gear housing 11B and the second faucet portion 42 of the motor case 31 and in the middle portion in the axial direction of the faucet portions 41 and 42. Accordingly, the O-ring 43 is always brought into contact with the working surfaces having the defined sizes in the first faucet portion 41 and the second faucet portion 42 so as to be uniformly held in a peripheral direction between the working surfaces without being brought into contact with the beveled portions and the burred portions at the end portions of the first faucet portion 41 and the second faucet portion 42, thereby centering the gear housing 11B and the motor case 31 so as to coaxially assemble them and at the same time being held in an airtight manner. Therefore, it is possible to axially connect the output shaft 32 of the electric motor 30 to the drive shaft 33 of the gear housing 11B in an easy manner so as to improve a torque transmitting performance of the electric motor 30 and secure a sealing performance between the fitted portions.

(2) Since the O-ring 43 is engaged with the annular groove 42A provided in the middle portion in the axial direction of the first faucet portion 41 or the second faucet portion 42 so as to be attached thereto, the O-ring 43 can be securely and simply interposed at a proper position between the middle portion in the axial direction of the first faucet portion 41 and the middle portion in the axial direction of the second faucet portion 42 when assembling the gear housing 11B and the motor case 31. Further, there is no risk that the O-ring 43 falls out.

As heretofore explained, embodiments of the present invention have been described in detail with reference to the drawings. However, the specific configurations of the present invention are not limited to the embodiments but those having a modification of the design within the range of the present invention are also included in the present invention.

As mentioned above, in accordance with the present invention, in the electric power steering apparatus, it is possible to coaxially connect the output shaft in the electric motor side to the drive shaft in the gear housing side in an easy manner so as to improve performance in transmitting torque of the electric motor.

Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be embodied within a scope encompassed and equivalents thereof with respect to the features set out in the appended claims.

What is claimed is:

1. An electric power steering apparatus comprising:
a gear housing; and
a motor case of an electric motor mounted to the gear housing,
wherein an O-ring is interposed between a middle portion in an axial direction of a first faucet portion provided in the gear housing and a middle portion in an axial direction of a second faucet portion provided in the motor case upon fitting the second faucet portion to the first faucet portion.

2. An electric power steering apparatus as claimed in claim 1, wherein an annular groove for attaching the O-ring is provided in a middle portion in an axial direction of said first faucet portion or said second faucet portion.

3. An electric power steering apparatus as claimed in claim 1, wherein an output shaft of said electric motor and a drive shaft supported to said gear housing and integrally having a worm gear in the middle portion are coaxially connected to each other, and a worm wheel fixed to a pinion shaft supported to said gear housing is engaged with said worm gear.
